(19) United States
(12) Patent Application Publication
(10) Pub. No.: US 2013/0096911 A1
(43) Pub. Date: Apr. 18, 2013

(54) NORMALISATION OF NOISY TYPEWRITTEN TEXTS

(71) Applicants: Richard Beaufort, Corbais (BE); Cédrick Fairon, Etterbeek (BE)

(72) Inventors: Richard Beaufort, Corbais (BE); Cédrick Fairon, Etterbeek (BE)

(73) Assignee: UNIVERSITE CATHOLIQUE DE LOUVAIN, Louvain-La-Neuve (BE)

(21) Appl. No.: 13/642,302

(22) PCT Filed: Apr. 21, 2011
(86) PCT No.: PCT/EP2011/056485

§ 371 Date: Dec. 31, 2012

(30) Foreign Application Priority Data
Apr. 21, 2010 (EP) 10004230.8
May 27, 2010 (EP) 10005506.0

(51) Int. Cl. G06F 17/28

(52) U.S. Cl. CPC G06F 17/28
USPC 704/9

(57) ABSTRACT

Described herein is a method and system for normalising a SMS sequence in which the sequence is pre-processed to identify noisy segments in the sequence, normalising those noisy segments and normalising the rest of the SMS sequence in accordance with predefined rules. A morphosyntactic analysis is carried out on the normalised text before an output is provided either as a typewritten text or as a synthetic speech signal.

The present invention relates to normalisation of noisy typewritten texts, and is more particularly, although not exclusively, concerned with a method and a system for normalising SMS messages.

It is well-known that Short Message Service (SMS) offers the possibility of exchanging written messages between mobile phones. These messages, in most cases, deviate greatly from traditional spelling conventions regardless of the language. As described in the article “Generation txt? The sociolinguistics of young people's text-messaging” by Thurlow and Brown, published in Disclosure Analysis Online, 2003, or in the article by Fairon et al., “le language SMS étude d'un corpus informatisé à partir de l'enquête faites don vos SMS à la science”, 2006, this deviation is due to the simultaneous use of numerous coding strategies like: phonetic plays, for example, 2m1 to read as ‘demain’ or “tomorrow”; phonetic transcriptions, for example, kom instead of ‘comme’ or “like”; consonant skeletons, for example, tjrs for ‘toujours’ or “always”; and abusive, missing or incorrect separators, for example, j esper for ‘j'espère’ or “I hope”, j'croibi1k instead of ‘je crois bien que’ or “I am pretty sure that”, etc.

These deviations are due to three main factors: the small number of characters allowed by the service, usually 140 bytes; the constraints due to small keypads on the mobile phones; and the fact that people mostly communicate between friends and relatives, in an informal register.

Whatever the causes, these deviations considerably hamper any standard natural language processing (NLP) system which stumbles against so much out-of-vocabulary (OOV) words. For this reason, as noted by Sporat et al. in their article “Normalization of Non-Standard Words”, published in Computer Speech & Language 15(3): pages 287 to 333, 2001, an SMS normalisation must be performed before a more conventional NLP process can be applied. It should be noted that SMS normalisation consists of rewriting an SMS text using a more conventional spelling in order to make it more readable for a human or for a machine.

Up to now SMS normalisation has been handled through three well-known NLP metaphors: spell checking, machine translation and automatic speech recognition. The spell checking metaphor performs the normalisation task on a word-per-word basis. On the assumption that most words should be correct for the purpose of communication, its principle is to keep In-Vocabulary (IV) words out of the correction process. It is further known to use a rule-based system that uses only a few linguistic resources dedicated to SMS, like specific lexicons of abbreviations. It is also known to implement the noise channel approach, which assumes a communication process in which a sender emits the intended message W through an imperfect (noisy) communication channel, such that the sequence O observed by the recipient is a noisy version of the original message. On this basis, the idea is to retrieve the intended message W hidden behind the sequences of observations O, by maximising:

$$\begin{matrix}{W}_{max} = argmax P ( W \vert O ) \\ = argmax \frac{P ( O \vert W ) P ( W )}{P ( O )}\end{matrix} \qquad ( 1 )$$

where P(O) can be ignored, because it is constant, P(O|W) models the noise of the channel, and P(W) models the language of the source.

The noisy channel was implemented through a Hidden-Markov Model (HMM) able to handle both graphemic variants and phonetic plays. This model was enhanced by adapting the noise P(O|W,wf) of the channel in accordance with a list of predefined observed word formations {wf}: stylistic variation, word clipping, phonetic abbreviations, etc. Whatever the system, the main limitation of the spell checking approach is probably having too high confidence in word boundaries.

The machine translation metaphor considers the process of normalising SMS as a translation task from a source language (the SMS) to a target language (its standard written form). This technique is based on the observation that, on the one hand, SMS messages greatly differ from their standard written forms, and that, on the other hand, most of the errors overrun the word boundaries and require a wider context in order to be resolved.

On this basis, a statistical machine translation model was proposed which works at the phrase-level, by splitting sentences into their k most probable phrases. While this approach achieves really good results, the assumption was made that a phrase-based translation can hardly capture the lexical creativity observed in SMS messages. Moreover, the translation framework, which can handle many-to-many correspondences between sources and targets, exceeds the needs of SMS normalisation, where the normalisation task is almost deterministic.

The automatic speech recognition (ASR) metaphor is based on the observation that SMS messages present a lot of phonetic plays that make sometimes the SMS word, for example, sré, or mwa, closer to its phonetic representation, [sKe] or [mwa], than to its standard written form serai (“will be”) or moi (“me”). Typically, an ASR system tries to find the best word sequence within a lattice of weighted phonetic sequences. Applied to the SMS normalisation task, the ASR metaphor requires that the SMS message is first converted into a phone lattice, before turning it into a word-based lattice using a phoneme-to-grapheme dictionary. A language model is then applied on the word lattice, and the most probable word sequence is finally chosen by applying a best-path algorithm on the lattice. One of the advantages of the grapheme-to-phoneme conversion is its intrinsic ability to handle word boundaries. However, this step also presents an important drawback, as it prevents next normalisation steps from knowing what graphemes were in the initial sequence.

It is therefore an object of the present invention to provide an SMS normalisation method that is based on normalisation models determined in accordance with a training corpus.

In another object of the invention, different normalisation models can be applied to a noisy sequence depending on whether the sequence has been labelled by the system as being known (IV) or not known (OOV).

In further object of the invention, the normalisation process handles word boundaries and avoids normalisation of unambiguous tokens, such as, URLs, phone numbers, currencies, etc., that need to be kept as they are.

In accordance with a first aspect of the present invention, there is provided a method for normalising SMS sequences, the method comprising the steps of:—a) receiving an SMS sequence to be processed;

b) processing the SMS sequence to provide a normalised text corresponding to the SMS sequence; c) processing the normalised text to provide a morphosyntactic analysis of the normalised text; and d) producing an output indicative of the normalised text.

The output may comprise a printed normalised text and/or a synthetic speech signal corresponding to the normalised text. This exploits the pieces of information (token labelling and morphosyntactic analysis) provided by the two first steps. If the output is a printing of the normalised text, the system uses these pieces of information to follow and apply the basic rules of typography. If the output is a synthetic speech signal corresponding to the normalised text, the system uses these pieces of information to decide on the way each token of a text and each word of a token needs to be pronounced. In addition, the output may comprise both the typewritten text and the synthetic speech.

Step b) comprises the sub-steps of: (i) pre-processing the SMS sequence to identify noisy segments; (ii) normalising the identified noisy segments in the SMS sequence; and (iii) post-processing the noisy segments.

Ideally, sub-step (i) comprises detecting at least one of paragraphs, sentences and unambiguous tokens in the SMS sequence, and labelling all other portions of the SMS sequence as noisy segments. Unambiguous tokens may include URLs, phone numbers, dates, times, currencies, units of measurement and, last but not least in the context of SMS, smileys. Any other sequence of characters is considered to be noisy and is labelled as such.

Once the noisy segments have been identified, sub-step (ii) comprises applying a first normalisation model to the noisy segments to identify in-vocabulary words and out-of-vocabulary words, each noisy segment being split into sub-segments corresponding to in-vocabulary words and out-of-vocabulary words.

Sub-step (iii) may comprise detecting non-alphabetic segments in the normalised noisy segments and isolating the detected non-alphabetic segments as at least one distinct token. At this stage, for instance, a point becomes a ‘strong punctuation’. Apart from the list of tokens already managed by the pre-processing sub-step, this sub-step handles, as well as numeric and alphanumeric strings, fields of data (like bank account numbers), punctuation marks and symbols.

It is preferred that step b) comprises using a second normalisation model to identify in-vocabulary words. In addition, a third normalisation model may also be used to identify out-of-vocabulary words.

In a preferred embodiment, the normalisation models are built in a training step preceding the above-mentioned steps. Three models are learned, R_{IV}, R_{OOV}, and Sp, where R_{IV} is a model dedicated to IV words, R_{OOV} is a model dedicated to OOV words, and Sp is a model able to distinguish IV words and OOV words inside a noisy segment or sequence, and to split this segment or sequence in sub-segments or sub-sequences of IV words and OOV words.

Advantageously, the sub-step of normalising noisy segments or sequences uses the three normalisation models learned in the training step as follows. First, Sp is applied on the noisy sequence or segment, which is split into sub-segments or sub-sequences of IV words and OOV words. Secondly, each sub-segment or sub-sequence is normalised using the model corresponding to its kind: R_{IV} if the subsequence contains IV words, R_{OOV} if the sub-sequence contains OOV words.

Advantageously, the training step exploits two parallel corpora: an SMS corpus and its transcription, aligned at the character level. This character-level alignment is obtained by applying a new string alignment algorithm that gradually learns the best way of aligning strings.

In accordance with another aspect of the present invention, there is provided a system for normalising SMS sequences, the system comprising:—a computer server on which an application is loaded for carrying out the method as described above; and at least one client device connectable to the server to provide input SMS sequences for processing in accordance with the method as described above.

Ideally, the computer server comprises first and second processors, each processor having a copy of the application loaded onto to it. This provides a degree of flexibility in case one of the processors experiences problems and needs to be shut-down and re-started.

Advantageously, a monitoring module is connected to both the first and second processors. The monitoring module checks both the memory status and the operational status of each of the first and second processors.

The computer server has a single common entry pathway to which each client connects, the entry pathway directing requests for processing from the clients to the computer server sequentially in accordance with the order of arrival of the request in the entry pathway.

Similarly, the computer server has a single common error pathway that allows the computer server to advise all active clients about a problem with the system.

For a better understanding of the present invention, reference will now be made, by way of example only, to the accompanying drawings in which:

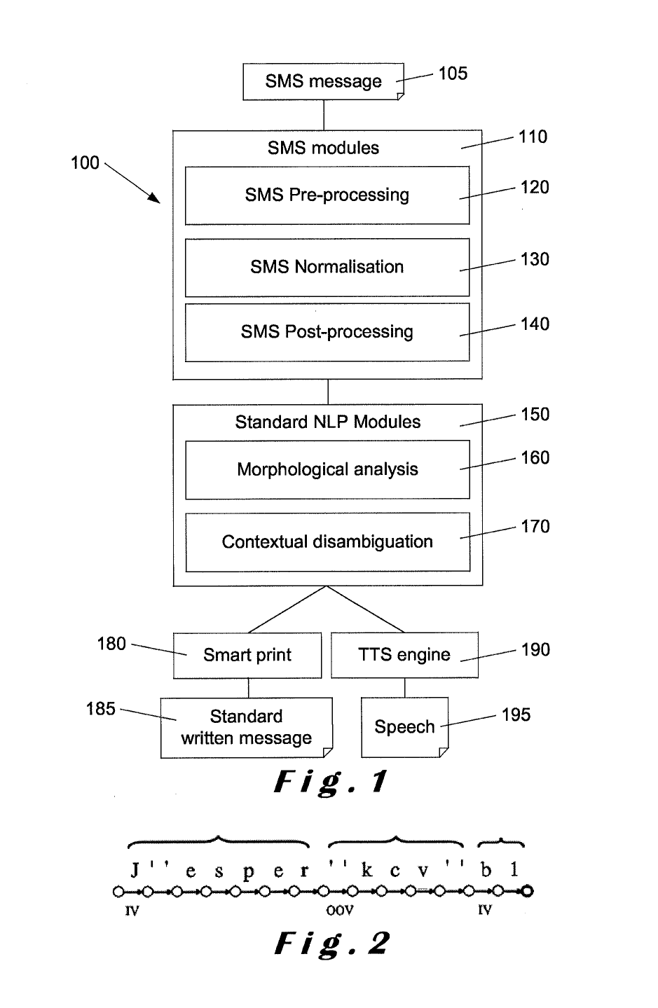

FIG. 1 illustrates SMS normalisation system architecture in accordance with the present invention;

FIG. 2 illustrates the application of a split model Sp on a noisy token;

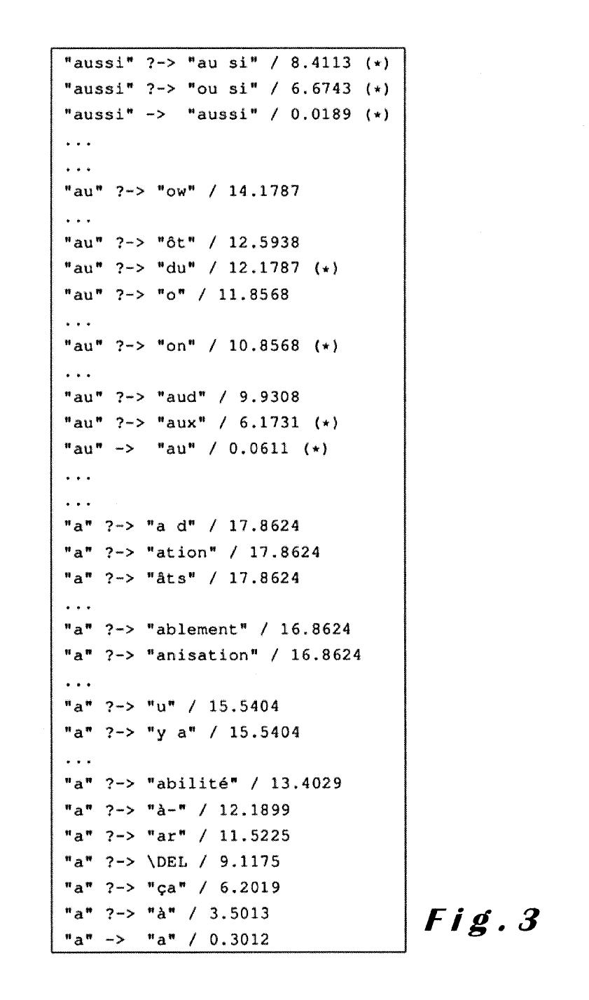

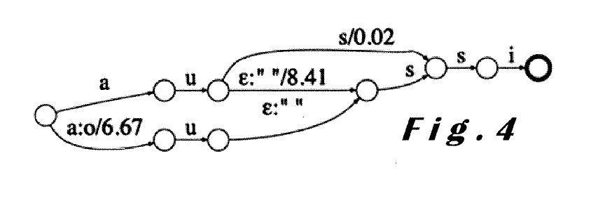

FIG. 3 illustrates long-to-short ordering of the rewrite rules of the OOV model;

FIG. 4 illustrates the application of the OOV model to the French work “aussi”;

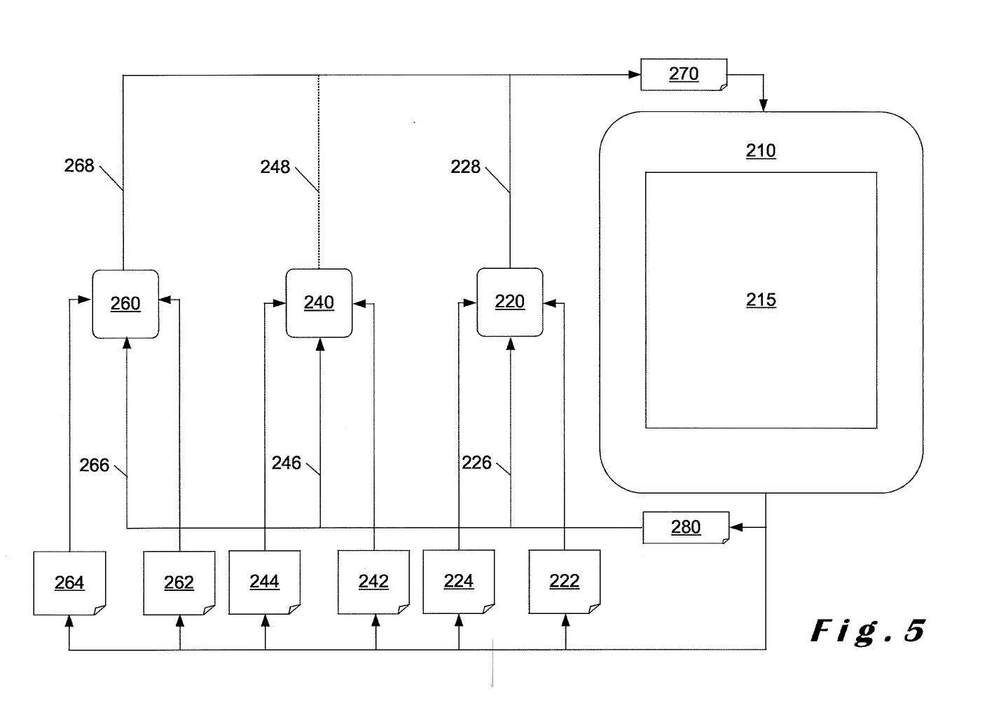

FIG. 5 illustrates web service architecture in accordance with the present invention; and

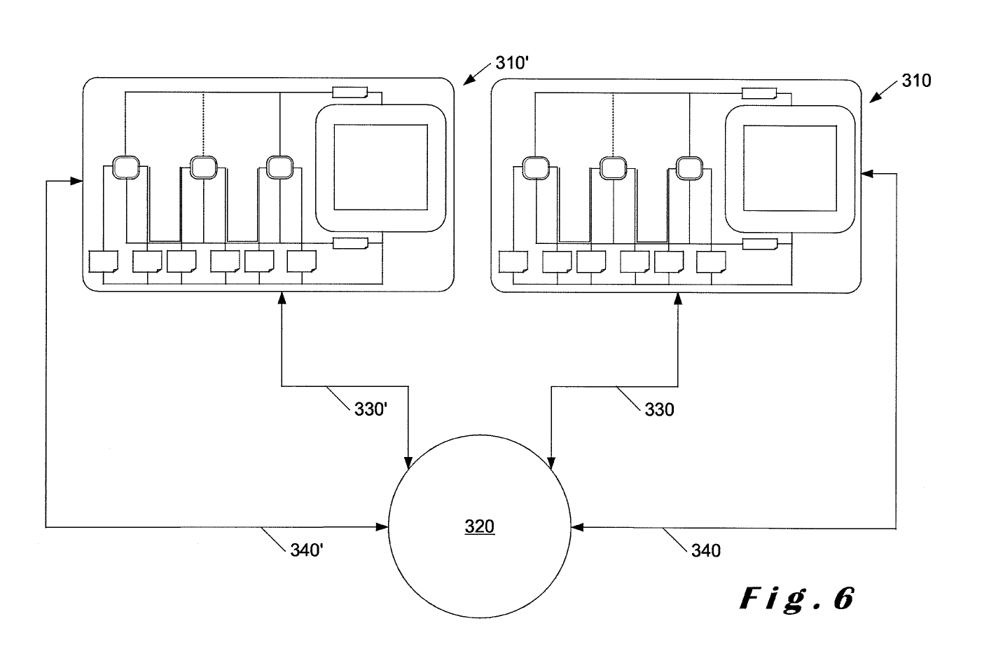

FIG. 6 illustrates a control system for checking the behaviour of the application installed on the server shown in FIG. 5.

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes.

The present invention relates to a method and a device for normalising noisy typewritten texts. The method of the invention relies on parallel corpora: a noisy corpus (of typewritten texts) and its normalised transcription. The invention is defined in the context of SMS messages because the parallel corpora used for designing the system are an SMS corpus and its normalised transcription. In addition, the state of the art is defined in terms of SMS language.

However, it will be appreciated that the method of the present invention may be applied to any kind of noisy typewritten text (chats, forums, blogs, optical character recognition (OCR)-based typewritten texts, ASR-based typewritten texts, etc.) as soon as dedicated parallel corpora are available.

For the sake of clarity, the method of the invention is only illustrated using French data. However, the method of the invention is language-independent, that is, it is not language specific and can be tailored for one or more individual languages.

“Typewritten text”, as used herein, refers to a computer file consisting solely of printable characters from a predetermined character set. A typewritten text may thus be acquired using different kinds of input devices, for example, a keyboard, an OCR system, an ASR system, etc.

“Noise” is commonly referred to as an unwanted perturbation added to a well defined signal (a sound, an image). In the context of typewritten texts, “noise” can be defined as any kind of difference between the surface form of a coded representation of the text and the intended, correct or original text.

“Noisy typewritten text” refers to a typewritten text that contains noise.

“Text normalisation”, as used herein, is the process of rewriting a noisy typewritten text using a correct and more conventional spelling, in order to make it more readable for a human or for a machine. “SMS message” or “text message” are well known terms in the art and refer to a typewritten text created on a (mobile) phone, using either the keyboard on a mobile phone (or similar device) or an embedded ASR system. “SMS normalisation” refers to the text normalisation defined above, specifically applied to an SMS message.

“Corpus” refers to large and structured set of texts.

“Parallel corpora” relates to two corpora that are translations of each other. In the context of the SMS language, parallel corpora refer to an SMS corpus and its transcription in a more conventional spelling.

“In-Vocabulary” (IV) relates to a word belonging to the electronic lexicon in which an application performs its lexicon looks-up.

“Out-Of-Vocabulary” (OOV) relates to a word missing from the electronic lexicon in which an application performs its lexicon looks-up.

In the method according to the invention, all lexicons, language models and sets of rules are compiled into finite-state machines (FSMs) and combined with the input text by composition (o). It should be noted that FSMs and their fundamental theoretical properties, like composition, are described in the state-of-the-art literature, as, for example, by Roche and Schabes, 1997, “Finite-State Language Processing”, MIT Press, Cambridge, Mass.; by Mohri and Riley, 1997, “Weighted Determinization and Minimization for Large Vocabulary Speech Recognition”, Proceedings of Eurospeech '97, pages 131 to 134; and by Mehryar Mohri, Fernando Pereira, and Michael Riley, 2001, “Generic ε-removal algorithm for weighted automata”, Lecture Notes in Computer Science, 2088, pages 230 to 242.

In particular, the method according to the invention relies on an FSM library and its associated compiler described by Richard Beaufort, 2008, “Application des Machines à Etats Finis en Synthèse de la Parole: Sélection d'unités non uniformes et Correction orthographique”, PhD Thesis, FUNDP, Namur, Belgium. In conformance with the format of the library, the compiler builds finite-state machines from weighted rewrite rules, weighted regular expressions and n-gram models.

The present invention mainly finds its foundations in the machine translation metaphor. Like in machine translation systems, the method relies on a training step performed on parallel corpora, and intrinsically handles word boundaries in the normalisation process if needed. However, contrary to machine translation approaches, the present invention relies on word boundaries when they seem sufficiently reliable, and is able to detect unambiguous units of text as soon as possible. These last two features tend to bring the present invention closer to the spell checking metaphor.

The present invention is thus halfway between the machine translation and the spell checking metaphors, and constitutes a real improvement of the two methods.

In accordance with the present invention, an SMS normalisation framework based on FSM was developed in the context of an SMS-to-speech synthesis system. The intention was to avoid incorrect modifications of special tokens and to handle word boundaries as efficiently as possible. The method shares similarities with both spell checking and machine translation. The normalisation algorithm is original as it based entirely on models learnt from a training corpus and a re-write model applied to a noisy sequence differs depending on whether the sequence is labelled as being known or not.

First, the model takes account of phonetic similarities because SMS messages contain a lot of phonetic plays. This phonetic model should know that o, au, eau, . . . , aux can all be pronounced [o], while è, ais, ait, . . . , aient are often pronounced [ε]. In accordance with the present invention, it is proposed that phonetic similarities are learnt from a dictionary of words with phonemic transcriptions and are used to build graphemes-to-graphemes rules which can automatically weighted by their learning frequencies from the aligned corpora.

Furthermore, the module should be able to allow for timbre variation, for example, [e] and [ε], so that similarities between graphemes frequently confused in French, like ai ([e]) and ais/ait/aient ([ε]), can be allowed for. Graphemes-to-graphemes rules should be contextualised so that the complexity of the model can be reduced.

It is also interesting to test the impact of another lexical language model learnt on non-SMS sentences. Indeed, the lexical model must be learned from sequences of standard written forms. Whilst this is an obvious prerequisite, it involves a major drawback when the corpus is made of SMS sentences as the corpus must first be transcribed in an expensive process that reduces the amount of data on which the model is trained. It is therefore proposed that the lexical model is learnt from non-SMS sentences. However, the corpus of external sentences should still share two important features with the SMS language, namely, it should mimic the oral language and be as spontaneous as possible.

Four constraints were formulated before fixing the architecture of the system:

1. Unambiguous tokens, like URLs, phones or currencies, should be identified as soon as possible, to keep them out of the normalisation process.

2. Word boundaries should be taken into account, as far as they seemed reliable enough. The idea, here, is to base the decision on a learning able to catch frequent SMS sequences to include in a dedicated IV lexicon.

3. Any other SMS sequence should be considered as OOV, on which in-depth rewritings may be applied.

4. The basic rules of typography and typesetting should be applied on the normalised version of the SMS message.

In order to put the present invention into context, first a dictionary built up out of an SMS corpus will be described. Three distinct steps enable the dictionary to be made: (1) corpus collection and transcription; (2) corpus alignment; and (3) raw SMS resource extraction.

The dictionary was built from a French SMS corpus of 30000 messages, gathered in Belgium. An example of an SMS corpus and its transcription constituting parallel corpora that are aligned at the message level is shown below:

Raw text:
Slt cv?Tfé koi 2 bo?Mi Gtudi é j comens a en avoir mar dè exam!M\grave{e}bon
cv plu ke 2jour é cè lè vac'!Alor on ua fèr koi pr l'anif 2 {???,.NOM}
et {???,.NOM)?Rèp stp bizZz
Transcription:
Salut ça va? Tu fais quoi de beau? Moi j'étudie et je commence à en
avoir marre des examens! Mais bon ça va {???,.MISS} plus que 2 jours et
c'est les vacances! Alors on va faire quoi pour l'anniversaire de
{???,.NOM} et {???,.NOM}? Réponds s'il te plait. Bise

However, in order to learn pieces of knowledge from these corpora, an alignment at the word level is needed. For each word of a sentence in the standard transcription, the corresponding sequence of characters in the SMS version needed to be known. As an accurate automatic linguistic analysis of the SMS corpus was not possible, another way of producing this word-alignment was needed, that is, a method capable of aligning sentences at the character level. This method is called “string alignment”. One way of implementing this string alignment is to compute the edit-distance of two strings, which measures the minimum number of operations (substitutions, insertions, deletions) required to transform one string into the other. Using this algorithm, in which each operation gets a cost of 1, two strings may be aligned in different ways with the same global cost. For instance, the couple (kozer, causé) could be aligned as shown below:

| | | | |
|---|---|---|---|
| (1) | ko_ser | (2) | k_oser |
| | cause_ | | causé_ |
| (3) | ko_ser | (4) | k_oser |
| | caus_é | | caus_é |

where underscores (_) mean “insertion” in the upper string, and “deletion” in the lower string. However, from a linguistic standpoint, only alignment (1) is desirable, because corresponding graphemes are aligned on their first character. In order to automatically choose this preferred alignment, three edit-operations needed to be distinguished according to the characters to be aligned. For that purpose, probabilities were required. Computing probabilities for each operation according to the characters to be aligned was performed through the following iterative algorithm:
STEP 1: Align the corpora using the standard edit-distance (with edit-cost of 1).
STEP 2: From the alignment, learn probabilities of applying a given operation on a given character.
STEP 3: Re-align the corpora using a weighted edit-distance, where the cost of 1 is replaced by the probabilities learned in STEP 2.
STEP 4: If two successive alignments provide the same result, there is a convergence and the algorithm ends. Otherwise, it goes back to STEP 2.

Hence, the algorithm gradually learns the best way of aligning strings. In the SMS parallel corpora in accordance with the present invention, the algorithm converged after 7 iterations and provided a result from which the learning could start. A sample of this result is provided below:
1. S_t_t c_v_?_T_fé_ k_oi 2_ b_o_!_M_i G_tudi_é_ j_ com_ens_ à
   Salut ça va? Tu fais quoi de beau? moi j'étudie et je commence à
2. D_t_t_Facon_J_en_Ai plu_Besoin
   De toute façon j'en ai plus besoin
3. G_besoin_{—}2_partaG_ k_k_l_stan_ a_c toi
   J'ai besoin de partager quelques instants avec toi
4. 7_rop b_o_{—} 7_ idylle k_i 7_ternise
   C'est trop beau cette idylle qui s'éternise

Based on this character-level alignment, an extraction script enabled extraction of raw and standard variants for each sequence. The script loaded a regular French language dictionary that allowed matching of SMS standard sequences with recognised inflected forms and their lemma. Here, each entry is not followed by its standard sequence but by its lemma as shown below:

Monitric|(monitrice)|moniteur|N+z1:fs

For ambiguous sequences that showed various lemmas, a new entry was created for each possible grammatical interpretation. The extraction script implements the following steps:
STEP 1: For each aligned pair {SMS message, standard message}
   Split the two messages according to blanks and punctuation in the standard message
For each pair of {SMS, standard} segments
   Clean segments, that is, remove insertion and deletions symbols “_” and convert each upper case into the corresponding lower case
   Store the pair in a temporary lexicon, except if the SMS sequence is empty or matches with a number/time pattern
STEP 2: For each stored pair from the temporary lexicon
   If the standard word exists in the DELAF lexicon (a general language electronic dictionary released under licence LGPLLR (http://www-igm.univ-mlv.fr/˜unitex/index.php?page=7)), for each DELAF lexicon entry {standard word, lemma, category}, create a new SMS to standard language dictionary (SSLD) entry {SMS sequence, lemma, category}
   Else, create a new SSLD entry {SMS sequence, UNKNOWN tag}

This filters out unwanted entries so as to obtain a smarter SSLD. All unknown sequences added to the SSLD by the extraction script were manually revised, for example, neologisms, word plays, proper names (toponyms, first names and trade marks), foreign words (monkey, besos, aanwezig, etc.), unrecognised sign/number patterns (07h5 for 07h05), emotive graphics (repetition of letters showing intensity) and transcribers' mistakes (cnpine for copine ‘girl friend’, premdr for prendre ‘to take’ etc.). All categories were kept, apart from proper names and transcribers' mistakes.

During this checking task, each SSLD entry was also labelled with one of the seven SMS categories defined in order to characterise the stylistic phenomena of the SMS corpus. Some ambiguous sequences, however, could not directly be associated with any of the categories and the initial corpus was reviewed for context. For example, the entry rè, whose lemma was trait, was difficult to label and could have been considered as an abbreviating phenomenon instead of being the last segment of the SMS form pRmeterè, which stood for permettrait (‘would permit’) and had been wrongly segmented into two entries by the extraction script.

Standard inflected words that satisfy standard spelling made up have of the SSLD entries. In the other half of the entries, some SMS phenomena were rapidly recognised, for example, the abbreviating process as well as phonetisation, a sub-category of abbreviation, which describes letters, numbers or signs used for their phonetic values. The use of signs and the use of numbers were distinguished. Two further categories were added, namely, a “mistakes” category including SMS user, transcriber, word-aligner or algorithm mistakes, and an “unlikelies” category which were not strictly speaking SMS phenomena but which have to be considered apart from other SMS phenomena. None of these categories was deleted as they all conveyed specific information that could be used to improve automatic SMS reading and understanding.

Having put numbers and signs aside, the phonetisation category was used to define any sequence that phonetically resembled the standard word. In this category, the following were included: strict phonetisation (pnible for pénible); any sequence showing schwa deletion (bêtis for bétise), and any simplification that maintains the phonetic resemblance (ail for aille, the subjunctive of aller, “to go”). This category was by far the most popular SMS graphic phenomenon because it includes any unaccentuated word.

The fact that, for ambiguous terms, a new entry is created for each possible lemma, ensures that a certain improvement of the dictionary but it also adds some ambiguity if, for example, the SSLD was to be used for automatic translation. For terms which could either be nouns or inflected verbs, for example, échange, the ambiguity has to be maintained and can probably be solved by the context. In other cases, the confusion is unnecessary because one of the lemmas is very frequency whilst others are fairly rare at least in the SMS context. This is what is termed an “unlikely”, a rare lemma, and all “unlikelies” were deleted from the dictionary.

In cases where a French homograph of a word in another language occurs, for example, muchas, mucher “to hide”, the French word is not frequent enough to maintain an entry in the SSLD dictionary. Nevertheless, this kind of entry is nod deleted straightaway but is marked with a special “unlikely” tag so that it can be identified and deleted later if required.

A sizeable part of unknown words that were re-introduced into the dictionary were words that entered the French language after 2001. These words mostly refer to new realities (fitness, monoparentalité) or to technologies (adsl, bipeur, pirateur). However, some of these words are merely new labels for well-known realities (criser “to be on edge”, tilter “to suddenly understand”, cafariser “to sadden, or moisversaire “a celebration that happens on the same day of each month).

Some other sequences labelled as unknown turned out to belong to some specific terminology, for example, acerifolia (botany), markopsien (marketing) and émollience (cosmetics). Such sequences were kept as part of the SMS user's lexicon.

Many known entries were identified as regionalisms and were included in the final dictionary. As the corpus was collected in Belgium, regionalisms were mostly Belgian or at least shared by Belgium and other French-speaking areas. Words like baraki, berdeller, copion, guindaille and se faire carotter illustrate this trend.

It was found that the first mistakes were due to the transcriber himself. Even when he carefully checks his work, a single transcriber is not enough to avoid accidental mistakes which, of course, occurred quite frequently for a 30000 SMS corpus. The transcriber can be helped by checking his transcription several times, but not even multiple checking will find all the mistakes. A complementary solution could be to perform automatically lexicon look-ups during the transcription process and to draw the transcriber's attention to possible OOV words or infrequent forms.

Three kinds of mistakes are considered to be due to the alignment algorithm. First, cases of agglutination are frequent and the aligner shows a clear tendency to align on the first of two words when a letter is missing, for example:
D_t_t_Facon_J_en_Ai Plu_Besoin:=—D D_c_Fo_PluS_tréssé_.
   De toute façon j'en ai plus besoin:—D Donc faut plus stresser.

Secondly, some typography is not handled, such as, the ampersand, ‘&’, symbol, which is not recognised as et, or the digit ‘1’ being identified as the letter ‘i’. For example:
G_besoin_{—}2_partaG_k_k1_s_tan_a_c toi
   J'ai besoin de partager quelques instants avec toi

Thirdly, some subtle cases of phonetisation are not taken into account by the process, as is the case with letters, numbers or signs that replace more than one word.

These errors are due to the fact that the alignment works without resort to linguistics. It simply iteratively computes affinities of association between letters, and uses them to improve gradually the character-level alignment. However, as recent linguistic studies show, phonetic transcriptions (sré instead of serai “[I] will be”, kom instead of comme “as”) and phonetic plays (2m1 instead of demain “tomorrow”, k7 instead of cassette “tape”) are very frequent in SMS. This could be exploited by the alignment which could perform its task through a phonetic version of the sequences to be aligned. The example given below provides an alignment that solves a kind of error depicted in the previous example:

| | |
|---|---|
| SMS text: | k_{———}k_{———} _ 1_stan_{——} |
| SMS phonetisation: | k_{———}k_{———} - e~_sta~_{——} |
| Standard phonetisation: | k_Elk_@z - e~_sta~_{——} |
| Standard text: | quelques''instants |

Of course, here, an important fact must be taken into account. While a standard written sentence can automatically be analysed and unambiguously phonetised by NLP applications, this is not the case for an SMS sentence. An SMS sentence is difficult to analyse and can be transcribed as a lattice of possible phonetisations. The alignment then faces the problem that the weight of the concurrent phonetisations needs to be considered in order to choose the best path in all possible phonetic alignments.

The extraction algorithm also showed some limits. The first issue is due to the deletion of characters considered as separators. Some ambiguous characters considered as separators were lost while they were used as signs for phonetic purposes or abbreviations. However, keeping extra punctuation would have generated too much noise.

The second issue relates to a loss of information due to the systematic neutralisation of the case as most upper case characters were at the beginning of sentences. Nevertheless, some upper case letters carried pieces of phonetic information that would have been useful in the reading of dictionary entries, for example, the T in ‘arT’ for arrête is always upper case.

The third issue related to identical buffers void of letters or numbers. While it was necessary to delete any number or time expression from our dictionary, it was also unfortunate to lose all character sequences that could have carried information, for example, emoticons.

All these limitations have a single origin. The extraction algorithm rates a couple of aligned sentences just as two strings of characters and make arbitrary choices only based on predefined sets of characters, that is, letters, punctuation, symbols, etc., without taking into account the context. Based on this observation, the algorithm was provided with an automatic morphosyntactic analysis of the normalised side of the alignment. This linguistic analysis should help the algorithm to split the sentence into the right segments and add the right entries to the SSLD.

Plays on letters are not really dealt with by the system as even when both the alignment and the extraction steps do not generate errors, some sequences did not correspond to lexical entries and should have been left out of the dictionary. In a similar way to the extraction algorithm, false entries could be rejected by the system by checking their linguistic analysis through an automatic analyser.

The method according to the present invention shares similarities with both spell checking and machine translation as mentioned above. The machine translation like module of the system performs the true normalisation task. It is based on models learnt from an SMS corpus and its transcription, aligned at the character level in order to get parallel corpora. Two spell checking like modules surround the normalisation module. The first one of these modules detects unambiguous tokens, like URLs or phone numbers, and keeps them out of the normalisation process. The second module, applied on the normalised parts only, identifies non-alphabetic sequences, such as, remaining punctuation, and labels them with the corresponding token. This helps greatly if the print module in the system follows the basic rules of typography.

In FIG. 1, architecture 100 comprises an SMS module 110 and an NLP module 150. SMS module 110 comprises a pre-processing unit 120, a normalisation unit 130 and a post-processing unit 140. The NLP module 150 comprises a morphological analysis unit 160 and a contextual disambiguation unit 170. The output from the NLP module 150 is then passed to a smart print module 180 that provides a standard written message 185 and to a text-to-speech (TTS) engine 190 that provides a speech output 195.

The architecture depicted in FIG. 1 directly relies on the constraints given above. In short, the SMS message 105 first goes through an SMS module 110, which normalises its noisy parts. Then, the NLP module 150 produces a morphosyntactic analysis of the normalised text. Smart print module 180 takes advantage of this linguistic analysis to print a text 185 that follows the basic rules of typography, or the TTS engine 190 synthesises the corresponding speech signal 195.

The SMS pre-processing unit 120 relies on a set of manually-tuned rewrite rules. Of course, it identifies paragraphs and sentences, but also some unambiguous tokens, such as, URLs, phone numbers, dates, times, currencies, units of measurement and, last but not least, in the context of SMS, smileys. These tokens are kept out of the normalisation process, while any other sequence of characters is considered, and labelled, as noisy.

The SMS normalisation unit 130 only uses models learned from a training corpus. It involves three steps. In a first step, an SMS-dedicated lexicon look-up differentiates between known and unknown parts of a noisy token. In a second step, a rewrite process creates a lattice of weighted solutions. The rewrite model differs depending on whether the part to rewrite is known or not. In a third step, a combination of the lattice of solutions with a language model is made, and the choice of the best sequence of lexical units is made. At this stage, the normalisation as such is completed.

Like the pre-processor unit 120, the post-processor unit 140 relies on a set of manually-tuned rewrite rules. Post-processing is only applied on the normalised version of the noisy tokens, with the intention of identifying any non-alphabetic sequences and to isolate them in a distinct token. At this stage, for instance, a point becomes a ‘strong punctuation’. Apart from the list of tokens already managed by the pre-processor unit 120, the post-processor unit 140 handles, in addition to well numeric and alphanumeric strings, fields of data (like bank account numbers), punctuations and symbols.

The morphosyntactic analysis is performed on the normalised text, sentence by sentence. Here, only the outlines of the modules are given, because they comprise state-of-the-art algorithms as described in the article by Beaufort mentioned above.

The morphological analysis only concerns alphabetic tokens, and aims at providing the complete set of grammatical labels (noun, verb, etc.) for each word of the token. This process is mainly based on a lexicon look-up in the case of IV words, but on an inflectional analysis of word endings in the case of OOV words. Both approaches award weights to each category t^{j}, according to a model p(wᵢ|t^{j}), trained on data. The morphological analysis ends by a detection of compound nouns and verbs.

The contextual disambiguation process is performed on a complete sentence W and consists in finding the best sequence of categories T by maximising:

$$\begin{matrix}{T}_{max} = argmax P ( T \vert W ) \\ = argmax P ( W \vert T ) P ( T )\end{matrix} \qquad ( 2 )$$

where P(W|T) was already computed by the morphological analysis, and P(T) is a 3-gram smoothed by linear interpolation (Beaufort et al., 2002). Categories integrated in T depend on the tokens: word-categories for punctuations, compound-categories for alphabetic tokens and token-values themselves for other tokens (URLs, currencies, etc.). This adaptation of the category-level according to the token significantly improves the model accuracy.

The smart print module 180, based on manually-tuned rules, checks either the kind of token or the grammatical category to make the right typography choices, such as, the insertion of a space after certain tokens (URLs, phone numbers), the insertion of two spaces after a strong punctuation (point, question mark, exclamation mark), the insertion of two carriage returns at the end of a paragraph, or the upper case of the initial letter at the beginning of the sentence.

The method according to the invention uses an approximation of the noisy channel metaphor. It differs from this general framework, because the model of the noise of the channel has been adapted depending on whether the noisy token, our sequence of observations, is In-Vocabulary or Out-Of-Vocabulary:

$$P ( O \vert W ) = \{ \begin{matrix}{P}_{IV} ( O \vert W ) & if O ∈ IV \\ {P}_{OOV} ( O \vert W ) & else\end{matrix} \qquad ( 3 )$$

Indeed, the method of the present invention is based on the assumption that applying different normalisation models to IV and OOV words should both improve the results and reduce the time processing. For this purpose, the first step of the method comprises composing a noisy token T with an finite state transducer (FST) Sp whose task is to differentiate between sequences of IV words and sequences of OOV words, by labelling them with a special IV or OOV marker. The token is then split in n segments sgᵢ according to these markers:

{sg}=Split(T∘Sp) (4)

In a second step, each segment is composed with a rewrite model according to its kinds: the IV rewrite model, R_{IV,} for sequences of IV words, and the OOV rewrite model, R_{OOV,} for sequences of OOV words:

$${sg}_{i}^{′} = \{ \begin{matrix}{sg}_{i} & {R}_{IV} & if {sg}_{i} IV \\ {sg}_{i} & {R}_{OOV} & else\end{matrix} \qquad ( 5 )$$

All rewritten segments are then concatenated together in order to get back the complete token:

T=⊙ᵢ₌₁ⁿ(sg′ᵢ) (6)

where ⊙ is the concatenation operator.

The third and last normalisation step is applied on a complete sentence S. All tokens Tⱼ of S are concatenated together and composed with the lexical language model (LM). The result of this composition is a word lattice, of which we take the most probable word sequence S′ by applying a best-path algorithm:

S′=BestPath((⊙ⱼ₌₁^{m}Tⱼ)∘LM) (7)

where m is the number of tokens of S. In S′, each noisy token Tⱼ of S is mapped onto its most probable normalisation.

Having provided a point at which learning could start, the next step is the learning of the normalisation models. In NLP, a word is commonly defined as “a sequence of alphabetic characters between separators”, and an IV word is simply a word that belongs to the lexicon in use.

In SMS messages, however, separators are surely indicative, but not reliable. For this reason, our definition of the word is far from the previous one, and originates from the string alignment.

After examining parallel corpora aligned at the character-level, it was decided to consider a word as being “the longest sequence of characters parsed without meeting the same separator on both sides of the alignment”. For instance, the following alignment:
J esper_{—} k_tu va_{—}
J'espère que tu vas
(I hope that you will)
   corresponds to 3 SMS words according to our definition, since the separator in “J esper” is different from its transcription, and “ktu” does not contain any separator.

Thus, a first parsing of our parallel corpora provided us with a list of SMS sequences corresponding to our IV lexicon. The first model, the FST Sp, is built on this basis:

Sp=(S(I|O)(S*(I|O))S)G (8)

where:

I is an FST corresponding to the lexicon, in which IV words are mapped onto the IV marker.

O is the complement of I. In this OOV lexicon, OOV sequences are mapped onto the OOV marker.

S is an FST corresponding to the list of separators (any non-alphabetic and non-numeric character), mapped onto a separator or SEP marker.

G is an FST able to detect consecutive sequences of IV words, and to group them under a unique IV marker. By gathering sequences of IVs and OOVs, SEP markers disappear from Sp.

FIG. 2 illustrates the composition of Sp with the SMS sequence “J esper kcv b1” (J'espère que ça va bien, “I hope you are well”). For the example, we make the assumption that kcv was never seen during the training. The OOV sequence starts and ends with separators as shown.

The second model, the FST R_{IV}, is built during a second parsing of our parallel corpora. In short, the parsing simply gathers all possible normalisations for each SMS sequence put, by the first parsing, in the IV lexicon. Contrary to the first parsing, this second one processes the corpus without taking separators into account, in order to make sure that all possible normalisations are collected.

Each normalisation w for a given SMS sequence w is weighted as follows:

$$p ( \overline{w} \vert w ) = \frac{Occ ( \overline{w} , w )}{Occ ( w )} \qquad ( 9 )$$

where Occ(x) is the number of occurrences of x in the corpus. The FST R_{IV} is then built as follows:

R_{IV}=S_{IV}*IV_{R}(S_{IV}*IV_{R})*S_{IV}* (10)

where:

IV_{R} is a weighted lexicon compiled into an FST, in which each IV sequence is mapped onto the list of its possible normalisations.

S_{IV} is a weighted lexicon of separators, in which each separator is mapped onto the list of its possible normalisations. The deletion is often one of the possible normalisation of a separator. Otherwise, the deletion is added and is weighted by the following smoothed probability:

$$p ( DEL \vert w ) = \frac{0.1}{Occ ( w ) + 0.1} \qquad ( 11 )$$

In contrast to the other models, the third model, the FST R_{OOV}, is not a regular expression made of weighted lexicons. It corresponds to a set of weighted rewrite rules learnt from the alignment as discussed by Noam Chomsky and Morris Halle, 1968, “The sound pattern of English”, Harper and Row, New York; by C. Douglas Johnson, 1972, “Formal aspects of phonological description”, Mouton, The Hague; and by Mehryar Mohri and Richard Sproat, 1996, “An efficient compiler for weighted rewrite rules”, In Proc. ACL '96, pages 231 to 238). Developed in the framework of generative phonology, rules take the form:

φ→ψ:λ_ρ/ω (12)

which means that the replacement φ→ψ is only performed when φ is surrounded by λ on the left and ρ on the right, and gets the weight ω. However, in our case, rules take the simpler form:

φ→ψ/ω (13)

which means that the replacement φ→ψ is always performed, whatever the context. Inputs of our rules (φ) are sequences of 1 to 5 characters taken from the SMS side of the alignment, while outputs (ψ) are their corresponding normalisations. Our rules are sorted in the reverse order of the length of their inputs: rules with longer inputs come first in the list.

Long-to-short rule ordering reduces the number of proposed normalisations for a given SMS sequence for two reasons:

1. the firing of a rule with a longer input blocks the firing of any shorter sub-rule. This is due to a constraint expressed on lists of rewrite rules: a given rule may be applied only if no more specific and relevant rule has been met higher in the list;

2. a rule with a longer input usually has fewer alternative normalisations than a rule with a shorter input does, because the longer SMS sequence likely occurred paired with fewer alternative normalisations in the training corpus than did the shorter SMS sequence.

Among the wide set of possible sequences of 2 to 5 characters gathered from the corpus, we only kept in our list of rules the sequences that allowed at least one normalisation solely made of IV words. It is important to notice that, here, we refer to the standard notion of IV word. While gathering the candidate sequences from the corpus, each word of the normalisations was checked against a lexicon of French standard written forms. The lexicon we used contains about 430,000 inflected forms and is derived from Morlex, a French lexical database (see http://bach.arts.kuleuven.be/pmertens/).

FIG. 3 illustrates these principles by focusing on 3 input sequences: ‘aussi’, ‘au’ and ‘a’. As shown by FIG. 3, all rules of a set dedicated to the same input sequence (for instance, aussi) are optional (?→), except the last one, which is obligatory (→). In our finite-state compiler, this convention allows the application of all concurrent normalisations on the same input sequence, as depicted in FIG. 4.

In our real list of OOV rules, the input sequence ‘a’ corresponds to 231 normalisations, while ‘au’ accepts 43 normalisations and ‘aussi’, only 3. This highlights the interest, in terms of efficiency, of the long-to-short rule ordering.

The fourth trained model is a 3-gram of lexical forms, smoothed by linear interpolation, estimated on the normalised part of the used training corpus and compiled into a weighted FST LM_{w}.

At this point, this FST cannot be combined with our other models, because it works on lexical units and not on characters. This problem is solved by composing LM_{w} with another FST L, which represents a lexicon mapping each input word, considered as a string of characters, onto the same output words, but considered here as a lexical unit. Lexical units are then permanently removed from the language model by keeping only the first projection (the input side) of the composition:

LM=FirstProjection(L∘LM_{w}) (14)

In this model, special characters, like punctuation or symbols, are represented by their categories (light, medium and strong punctuation, question mark, symbol, etc.), while unambiguous tokens, like URLs or phone numbers, are handled as token values (URL, phone, etc.) instead of as sequences of characters. This reduces the complexity of the model.

As explained earlier, tokens of a same sentence S are concatenated together at the end of the second normalisation step. During this concatenation process, sequences corresponding to unambiguous tokens are automatically replaced by their token values. Special characters, however, are still present in S. For this reason, S is first composed with an FST Reduce, which maps each special character onto its corresponding category:

S∘Reduce∘LM

The performance and the efficiency of the invention were evaluated on a MacBook Pro with a 2.4 GHz Intel Core 2 Duo CPU, 4 GB 667 MHz DDR2 SDRAM, running Mac OS X version 10.5.8.

The evaluation was performed on the corpus of 30,000 French SMS by ten-fold cross-validation. The principle of this method of evaluation is to split the initial corpus into 10 subsets of equal size. The system is then trained 10 times, each time leaving out one of the subsets from the training corpus, but using only this omitted subset as test corpus.

Table 1 below presents the results in terms of efficiency. The system seems efficient, while we cannot compare it with other methods, which did not provide us with this information.

TABLE 1

| | mean | dev. |
|---|---|---|
| Bytes/sec | 1836.57 | 159.63 |
| Ms/SMS (140 b) | 76.23 | 22.34 |

Table 2 illustrates a comparison of the present invention, in part 1, with state of the art approaches, in part 2.

TABLE 2

| | 1. Our approach | | | | 2. State of the art | | | | | |
|---|---|---|---|---|---|---|---|---|---|---|
| | Ten-fold cross-validation, French | | | | French | | | English | | |
| | Copy | | Hybrid | | Guimier | Kobus 2008 | | Aw | Choud. | Cook |
| | x̅ | σ | x̅ | σ | 2007 | 1 | 2* | 2006 | 2006** | 2009** |
| Sub. | 25.90 | 1.65 | 6.69 | 0.45 | | 11.94 | | | | |
| Del. | 8.24 | 0.74 | 1.89 | 0.31 | | 2.36 | | | | |
| Ins. | 0.46 | 0.08 | 0.72 | 0.10 | | 2.21 | | | | |
| WER | 34.59 | 2.37 | 9.31 | 0.78 | | 16.51 | 10.82 | | 41.00 | 44.60 |
| SER | 85.74 | 0.87 | 65.07 | 1.85 | | 76.05 | | | | |
| BLEU | 0.47 | 0.03 | 0.83 | 0.01 | 0.736 | | 0.8 | 0.81 | | |

x̅ = mean, σ = standard deviation
*Kobus 2008-1 corresponds to the ASR-like system, while Kobus 2008-2 is a combination of this system with a series of open-source machine translation toolkits.
**Scores obtained on noisy data only, out of the sentence's context.

In part 1, the performance of our approach (Hybrid) and compares it to a trivial copy-paste (Copy) is provided. The system was evaluated in terms of BLEU score (Papineni et al., 2001), Word Error Rate (WER) and Sentence Error Rate (SER).

Concerning WER, the table presents the distribution between substitutions (Sub), deletions (Del) and insertions (Ins). The copy-paste results just provide information about the real deviation of our corpus from the traditional spelling conventions, and highlight the fact that our system is still at pains to significantly reduce the SER, while results in terms of WER and BLEU score are quite encouraging.

In part 2, the state-of-the-art approaches are summarised. The only results truly comparable to ours are those of Guimier de Neef et al. (2007). Whilst the approach used by Guimier de Neef et al. is based on the same corpus as the present invention, Table 2, as a whole, clearly, indicates that the method of the present invention outperforms the method of Guimier de Neef et al. Our results also seem a bit better than those of Kobus et al. (2008a), although the comparison with this system, also evaluated in French, is less easy. They combined the French corpus we used with another one and performed a single validation, using a bigger training corpus (36,704 messages) for a test corpus quite similar to one of our subsets (2,998 SMS). Other systems were evaluated in English, and results are more difficult to compare, but at least, our results seem in line with them.

The analysis of the normalisations produced by the method according to the invention pointed out that, most often, errors are contextual and concern: the gender, for example, quel(le) or “what”; the number, for example, bisou(s) or “kiss”); the person, for example, [tu t']inquiète(s) or “you are worried”; or the tense, for example, arrive/arriver or “arrived”/“to arrive”. This amount of contextual errors is not surprising in French, as language in which n-gram models are unable to catch this information, generally out of their scope.

On the other hand, this analysis confirmed our initial assumptions. First, unambiguous tokens (URLs, phones, etc.) are not modified. Second, agglutinated words are generally split, for example, Pensa ms→Pense à mes or “think to my”, while abusive separators tend to be deleted, for example, G t→J'étais or “I was”. Of course, we also found some errors at word boundaries, for example, [il] l'arrange→[il] la range or “[he] arranges”→“[he] puts in order”, but these were fairly rare.

The method according to the invention can be implemented in apparatus as described below with reference to FIGS. 5 and 6.

The goal is to enable users of mobile phones to add a function of “normalisation” with features already present on their mobile phone. The principle is therefore to offer them a plug-in, downloadable from a website and installable on their mobile phone. A good example of this type of website is the Apple Store (http://store.apple.com/), which provides many applications for Mac and iPhone.

This plug-in has the aim of making life easier for the user of the mobile phone. The user, after having written his/her text and selected the recipient(s) as he/she usually does, simply chooses “Normalisation” added by the plug-in to the “Send” menu on his/her mobile phone. Choosing the option “Normalisation” activates the plug-in, which will prompt the user to choose between the options “text-it” which sends the recipient or addressee a standard text, the option “voice-it” which sends the recipient or addressee synthesised speech corresponding to the standard text. This choice having been made, the message and number of the addressee can be sent together to the server for processing. The server, after having processed the SMS, will send the result chosen, normalised text or synthesised voice, to the addressee.

To achieve this goal, the normalisation application has to be installed on a server accessible to users. This requires that the application:

1. can operate in “server” mode, that is to say, wait for client requests and respond as soon as they arrive; and

2. be monitored by another application that can interrupt or restart the process, if necessary, to ensure the robustness of the service.

The implementation required for these two requirements is detailed below. The development of a server means that client applications send requests to the server and await a response to these requests. In server mode, the application must therefore:

1. process sequentially requests that arrive at the server; and

2. do not select the wrong client when sending the response.

To meet these constraints, client-server architecture with full two-way communication is provided in accordance with the present invention. This avoids any risk of collision between two requests that have arrived at the server. The general principle is quite simple. The application has been provided with a server layer which loads the received requests, passes the requests to the application for processing, waits for requests to be processed in an infinite loop, and leaving this layer to unload the memory if the request is one for application shutdown.

The characteristics of the architecture implementation are as follows. The server layer is implemented as a file outside of the application and provides a RunServer function. This function implements the infinite loop that waits for incoming requests and passes them to the application for processing. The passage of the request to the application is very simple. The RunServer function takes, as a requirement, a function which must comply with a function prototype, which means that the function passed to the RunServer must simply meet a list of requirements to accept and to return the type of the requirement.

When launching the application, it is sufficient to specify what one wants to launch in server mode, and the application, after loading its data, will launch RunServer, passing it the function to be applied to the requests.

This implementation allows any application to be processed by the server, provided that the implementation of the application provides a function following the defined prototype function. Our server can therefore be reused for other applications-servers.

For a duplicate architecture, we used the so-called “named pipes”. Under Linux, a named pipe functions as a standard pipe input/output, except that it has a name that identifies it uniquely.

This offers several advantages:

1. Several applications can access the same named pipe, thereby establishing a multi-write and/or multi-read functionality.

2. Named pipes open, close and manage files as standard. It is very simple to use, and several concurrent writes in the same pipe will always be processed sequentially, thereby avoiding the risks of mixing data.

3. Named pipes can be opened in blocking mode. An application that uses a named pipe blocking input is therefore blocked so that no information is written to this pipe. The application then waits for requests without constantly interrogating the system avoiding having to use CPU time.

4. An application can use multiple named pipes, inlet and/or output. In our case, it was necessary to be able to produce as many output pipes as requests arriving at the server, in order to ensure full duplication between the server and each client.

On this basis, the client-server architecture 200 shown in FIG. 5 was developed.

In FIG. 5, a server 210 is shown that runs the application 215. Connected to the server 210 is a plurality of clients 220, 240, 260. Although only three clients are shown, it will be appreciated that any number of clients can be connected to the server 210. Each client 220, 240, 260 is connected to the server 210 by means of a common entry pipe 270 and a common error pipe 280. Each client 220, 240, 260 also has an individual error pipe 222, 242, 262 and an individual output pipe 224, 244, 264. Each client 220, 240, 260 is connected to the common entry pipe 270 by means of connections 228, 248, 268 and to the common error pipe 280 by means of connections 226, 246, 266 as shown.

As shown, the server 210 has a single pipe entry 270, through which all the clients 220, 240, 260 write. The server 210 processes requests sequentially in the order they arrived, and goes into standby (blocking pipe) when the pipe 270 is empty. Requests simply correspond to file names. The server 210 then reads the name in the pipe 270, and opens the corresponding file.

The server 210 also has a common error pipe 280. This pipe 280 allows the server 210 to notify all active clients that a problem concerning all has occurred, for example, an inability to load, destruction of its data, etc.

Each client 220, 240, 260 creates two pipes that are clean and open for reading. The server 210, when it begins processing the request of a client, opens two corresponding pipes for writing. For a given request, the server knows the names of the corresponding named pipes to open, because the names of these pipes correspond to the request, the file name plus a suffix “_out” for the first, and “_err” for the second as indicated by pipes 224, 244, 264 and 222, 242, 262 respectively. The first pipe is a pipe output 224, 244, 264 which allows writing of the name of the resultant file produced by processing. The second pipe is a pipe error 222, 242, 262 that allows the server 210 to indicate if an error occurred whilst processing the file. When the client has received the expected results, it cancels the pipes that have been created.

When the server 210 receives a stop request, it deletes the entry pipe and error pipe it has created.

Note that the machine that was used as the server 210 has a dual processor, loading into memory two copies of the application-server, each using one of two processors.

Although it is not desirable, it may happen that the application-server encounters a problem and crashes. Moreover, it can also happen that one wants to stop abruptly in-progress processing, for example, when a file that takes too much processing time in order to avoid a hold-up in the processing stack. Finally, it may be interesting to have the possibility to check the consistency of the processing produced by the application. In all cases, it is necessary to be able to monitor, from outside, what happens at the application-server.

For this reason, close to the application and the server developed in ANSI C, we have written in Perl, a small monitoring module for the application-server loaded in memory. The principle of this monitoring module is illustrated in FIG. 6.

In FIG. 6, two processors 310, 310′ are shown that correspond to the application server 210 shown in FIG. 5. As described above, the machine on which the server 210 is located has two processors and a copy of the application is loaded onto each processor 310, 310′. A server monitoring module 320 is connected to each processor 310, 310′ by means of memory connections 330, 330′ and process connections 340, 340′ as shown. The module 320 may be a Perl module, Perl being a high-level, general purpose, interpreted dynamic programming language.

The choice of a Perl module for the monitoring module is motivated by: 1) the great robustness of this scripting language, favourable robustness for the realisation of safe monitoring applications; and 2) the ability to effectively manage regular expressions, which facilitates the manipulation of character sequences and thus allows great flexibility in defining, via initialisation file, tasks to be repeated on different values.

In FIG. 6, it is to be noted that the monitoring module 320 performs two operations. The first operation is to verify the presence of application servers in the active memory, as indicated by connections 330, 330′. This inexpensive operation can be performed frequently, for example, every second. The second operation, as indicated by connections 340, 340′, is to verify that each application server 310, 310′ is functioning properly. This means a) it should return an expected result and b) the return should be made within a reasonable time to avoid congestion at the entry pipe. This second operation, although more expensive, is alternately performed on each instance of the application server, at a lower frequency, for example, every 5 seconds. This operation is performed by providing a file to the server whose processed outcome is known. The file, in turn, contains a text intended to encompass all processing types included the application.

These operations may give rise to three different actions:

1. Either the application server has disappeared from memory, which means it has crashed. In this case, the monitoring module re-launches the application.

2. Either the application server does not respond within the time required during the second test, which means that there is congestion, probably because the file is too large to process. In this case, the application server and all associated clients are removed, and application server is then re-launched.

3. Or, in the second test, a problem is reported by the application server. If it is handled incorrectly, the system actually does nothing, but could send a mail to report the problem. This is the preferred operation. However, if this is another problem, for example, absence of a pipe, the server and all clients are removed, and application server is then re-launched.

1. A method for normalising SMS sequences, the method comprising the steps of:
a) receiving an SMS sequence;
b) processing the SMS sequence to provide a normalised text corresponding to the SMS sequence;
c) processing the normalised text to provide a morphosyntactic analysis of the normalised text; and
d) producing an output indicative of the normalised text.

2. A method according to claim 1, wherein step d) comprises printing the normalised text.

3. A method according to claim 1, wherein step d) comprises providing a synthetic speech signal corresponding to the normalised text.

4. A method according to claim 1, wherein step b) comprises the sub-steps of:
(i) pre-processing the SMS sequence to identify noisy segments;
(ii) normalising the identified noisy segments in the SMS sequence; and
(iii) post-processing the noisy segments.

5. A method according to claim 4, wherein sub-step (i) comprises detecting at least one of paragraphs, sentences and unambiguous tokens in the SMS sequence, and labelling all other portions of the SMS sequence as noisy segments.

6. A method according to claim 4, wherein sub-step (ii) comprises applying a first normalisation model to the noisy segments to identify in-vocabulary words and out-of-vocabulary words, each noisy segment being split into sub-segments corresponding to in-vocabulary words and out-of-vocabulary words.

7. A method according to claim 4, wherein sub-step (iii) comprises detecting non-alphabetic segments in the normalised noisy segments and isolating the detected non-alphabetic segments as at least one distinct token.

8. A method according to claim 1, wherein step b) comprises using a second normalisation model to identify in-vocabulary words.

9. A method according to claim 1, wherein step b) comprises using a third normalisation model to identify out-of-vocabulary words.

10. A system for normalising SMS sequences, the system comprising:—
a computer server on which an application is loaded for carrying out the method according to any one of the preceding claims; and
at least one client device connectable to the server to provide input SMS sequences for processing in accordance with the method according to claim 1.

11. A system according to claim 10, wherein the computer server comprises first and second processors, each processor having a copy of the application loaded onto to it.

12. A system according to claim 11, further comprising a monitoring module connected to both the first and second processors.

13. A system according to claim 10, wherein the computer server has a single common entry pathway to which each client connects, the entry pathway directing requests for processing from the clients to the computer server sequentially in accordance with the order of arrival of the request in the entry pathway.

14. A system according to claim 10, wherein the computer server has a single common error pathway that allows the computer server to advise all active clients about a problem with the system.
